(19) United States
(12) Patent Application Publication
(10) Pub. No.: US 2019/0144748 A1
(43) Pub. Date: May 16, 2019

(54) Cu-MoTi ETCHING SOLUTION

(71) Applicant: SHENZHEN CHINA STAR OPTOELECTRONICS TECHNOLOGY CO., LTD., Shenzhen, Guangdong (CN)

(72) Inventors: Yue WU, Shenzhen (CN); Shan Li, Shenzhen (CN); Chunsheng JIANG, Shenzhen (CN); Chia-Yu Lee, Shenzhen (CN)

(21) Appl. No.: 15/742,097

(22) PCT Filed: Nov. 24, 2017
(86) PCT No.: PCT/CN2017/112873

§ 371 Date: Jan. 5, 2018

(30) Foreign Application Priority Data
Nov. 10, 2017 (CN) 201711104710.9

(51) Int. Cl. C09K 13/06; C09K 13/00; C23F 1/18

(52) U.S. Cl. CPC C09K 13/06; C23F 1/18; C09K 13/00

(57) ABSTRACT

A Cu—MoTi etching solution is provided. The Cu—MoTi etching solution includes 5 to 30 wt % of an oxidant, 3 to 15 wt % of an acid, 3 to 15 wt % of an inorganic salt, and the balance deionized water. The oxidant is selected from hydrogen peroxide or persulfuric acid. The acid is selected from polycarboxylic acids, amino acids, or inorganic acids. The inorganic salt is selected from diammonium hydrogen phosphate or ammonium dihydrogen phosphate.

### FIELD OF INVENTION

This disclosure relates to etching solution technology, and more particularly to a copper, molybdenum, titanium (Cu—MoTi) alloy etching solution.

### BACKGROUND OF INVENTION

In production of TFT-LCDs, metal electrodes are generally formed by chemical etching methods. Specifically, a photoresist on a surface of a metal layer is first patterned to define a photoresist layer, and then an area not protected by the photoresist layer is etched away by chemicals. Then, the photoresist layer is peeled off to complete a patterned process of the metal layer. Conventional metal wires are generally composed of a multilayer alloy such as copper/molybdenum (Cu—Mo), copper/molybdenum-titanium alloy (Cu—MoTi), copper/titanium (Cu—Ti).

Conventional etching solutions for copper/molybdenum-titanium alloy contain fluorine ions. For example, a China patent “Etching Solution Composition Molybdenum Alloy Film of Indium Oxide Film” (Pub No. CN 103890234) discloses an etching-solution composition for a molybdenum alloy film, an indium oxide film or a multilayer film of a molybdenum alloy film and an indium oxide film. The etching-solution composition comprises, with respect to the total weight of the composition, between 5 and 25 wt. % of hydrogen peroxide, between 0.1 and 2 wt. % of a corrosion inhibitor, between 0.1 and 2 wt. % of a fluorine-containing compound, between 0.1 and 2 wt. % of a chlorine-containing compound, between 0.1 and 5 wt. % of a hydrogen peroxide stabilizer and water to make total weight of the entire composition up to 100 wt. %.

Although content of fluorine ions in the etching solution is relatively low, damage of such etching solution to a glass and an oxide semiconductor (IGZO) is very great. That limits reworked times in the patterned process of the metal layer and a development of IGZO in a BCE Structure.

Thus, it is necessary to provide a novel Cu—MoTi alloy etching solution to solve current technical problems.

### SUMMARY OF INVENTION

The disclosure provides a Cu—MoTi etching solution. The Cu—MoTi etching solution does not contain fluorine ions for preventing an etching solution damaging to a glass and an IGZO, thereby expanding applications of a patterned process of a metal layer.

In order to solve the above-mentioned drawbacks, the disclosure provides a Cu—MoTi etching solution, which comprises 5 to 30 wt % of an oxidant, 3 to 15 wt % of an acid, 3 to 15 wt % of an inorganic salt, and the balance deionized water.

In an embodiment of the disclosure, the Cu—MoTi etching solution comprises 8 to 12 wt % of the oxidant.

In an embodiment of the disclosure, the Cu—MoTi etching solution comprises 5 to 10 wt % of the acid.

In an embodiment of the disclosure, the Cu—MoTi etching solution comprises 5 to 10 wt % of the inorganic salt.

In an embodiment of the disclosure, the oxidant is selected from peroxy group-containing compounds. Preferably, the peroxy group-containing compounds are selected from hydrogen peroxide or its derivatives, for example, but not limited to, hydrogen peroxide and persulfuric acid.

In an embodiment of the disclosure, the acid is selected from the group consisting of a polycarboxylic acid, an amino acid, and an inorganic acid. Preferably, the acid is a polycarboxylic acid.

In an embodiment of the disclosure, the inorganic salt is selected from ammonium phosphate salts. Preferably, the ammonium phosphate salts are selected from the group consisting of ammonium dihydrogen phosphate, diammonium hydrogen phosphate, and ammonium phosphate. More preferably, the ammonium phosphate salt is diammonium hydrogen phosphate or ammonium dihydrogen phosphate.

In an embodiment of the disclosure, the polycarboxylic acids are selected from the group consisting of a malic acid and a citric acid. The amino acid is selected from, but not limited to, glycine or alanine. The inorganic acid is selected from phosphoric acid or sulfuric acid.

In an embodiment of the disclosure, the oxidant contained in the Cu—MoTi etching solution is preferably hydrogen peroxide.

In an embodiment of the disclosure, the acid contained in the Cu—MoTi etching solution is preferably citric acid.

In an embodiment of the disclosure, the disclosure provides a Cu—MoTi etching solution, which comprises 5 to 30 wt % of an oxidant, 3 to 15 wt % of a polycarboxylic acid, 3 to 15 wt % of an inorganic salt, and the balance deionized water. The oxidant is hydrogen peroxide. The polycarboxylic acid is citric acid. The inorganic salt is diammonium hydrogen phosphate or ammonium dihydrogen phosphate.

In a preferred embodiment of the disclosure, the etching solution contains 8 to 12 wt % of the oxidant. The oxidant is selected from the group consisting of hydrogen peroxide, and persulfuric acid. More preferably, the oxidant is hydrogen peroxide.

In a preferred embodiment of the disclosure, the Cu—MoTi etching solution comprises 5 to 10 wt % of the polycarboxylic acid. More preferably, the polycarboxylic acid is citric acid.

In a preferred embodiment of the disclosure, the Cu—MoTi etching solution comprises 5 to 10 wt % of the inorganic salt. The inorganic salt is diammonium hydrogen phosphate or ammonium dihydrogen phosphate.

In a preferred embodiment of the disclosure, the disclosure provides a Cu—MoTi etching solution, which comprises 8 to 12 wt % of an oxidant, 5 to 10 wt % of a polycarboxylic acid, 5 to 10 wt % of an inorganic salt, and the balance deionized water. The polycarboxylic acid is a malic acid or a citric acid. The inorganic salt is diammonium hydrogen phosphate or ammonium dihydrogen phosphate.

In a preferred embodiment of the disclosure, the disclosure provides a Cu—MoTi etching solution, which comprises 8 to 12 wt % of an oxidant, 5 to 10 wt % of a polycarboxylic acid, 5 to 10 wt % of an inorganic salt, and the balance deionized water. The oxidant is hydrogen peroxide. The polycarboxylic acid is a citric acid. The inorganic salt is diammonium hydrogen phosphate or ammonium dihydrogen phosphate.

In an embodiment of the disclosure, the Cu—MoTi etching solution further comprises 0.01 to 5 wt % of a metal chelating agent, the metal chelating agent is selected from the group consisting of an acminocarboxylate chelating agent, a hydroxycarboxylic acid chelating agent, a tartaric acid, a polyphosphate chelating agent, and a polycarboxylic acid chelating agent.

In an embodiment of the disclosure, the metal chelating agent is selected from the group consisting of ethylenediaminetetraacetic acid, hydroxyethyl ethylenediamine triacetic acid, polyacrylic acid, and polymethacrylic acid.

In an embodiment of the disclosure, the Cu—MoTi etching solution further comprises 0.01 to 5 wt % of a stabilizing agent.

In an embodiment of the disclosure, the stabilizing agent is phenyl urea.

It has been verified that when a concentration of hydrogen peroxide is less than 5 wt %, the Cu—MoTi alloy etching solution of the disclosure has a short effective period and is not suitable for industrial production. When a concentration of hydrogen peroxide is greater than 30 wt %, a danger of the Cu—MoTi alloy etching solution according to the disclosure is increased, which is unfavorable to a production safety.

When more glass substrates need to be processed, the metal chelating agent and/or the stabilizing agent can be added to the Cu—MoTi alloy etching solution according to the disclosure.

The disclosure provides a Cu—MoTi alloy etching solution. The Cu—MoTi alloy etching solution, which has a simple preparation method, a low manufacturing cost, a non-toxic side effect and without damage a glass and a IGZO, is obtained through reasonable choice and reasonable dosage of the oxidant, the polycarboxylic acid and the inorganic salt and a synergistic effect of the components thereamong. The Cu—MoTi alloy etching solution can replace conventional etching solutions containing fluorine ions for preventing the conventional etching solutions damaging to a glass and an IGZO, thereby expanding applications of a patterned process of a metal layer.

### DESCRIPTION OF DRAWINGS

The preferred embodiments being adopted by this disclosure to achieve the above and other objectives can be best understood by referring to the following detailed description of the preferred embodiments and the accompanying drawings as detailed below.

FIGS. 1A and 1B are microscopic view of an etching effect of a Cu—MoTi alloy etching solution described in Example 8 of the disclosure.

### DETAILED DESCRIPTION OF PREFERRED EMBODIMENTS

The specific details disclosed herein are merely representative and are intended to describe the purpose of the exemplary embodiments of this disclosure. This disclosure may be embodied in many and may not be construed as limited to the embodiments set forth herein.

### Embodiment 1. Cu—MoTi Etching Solution

In this embodiment, the disclosure provides a Cu—MoTi etching solution, which comprises 5 to 30 wt % of an oxidant, 3 to 15 wt % of an acid, 3 to 15 wt % of an inorganic salt, and the balance deionized water.

### Embodiment 2. Selection and Optimization of an Amount of the Oxidant

In this embodiment, a selection and dosage of the oxidant is optimized. In consideration of a cost control and a risk control of an etching process, hydrogen peroxide and persulfate are used as oxidants.

It has been verified that when a concentration of the hydrogen peroxide is less than 5 wt %, the obtained Cu—MoTi alloy etching solution has a short effective period. When a concentration of the hydrogen peroxide is greater than 30 wt %, a danger of the obtained Cu—MoTi alloy etching solution has potential safety hazards in operation. In this embodiment, a concentration of the oxidant is determined to range from 5 to 30%. In addition, considering an etching effect and a manufacturing cost, hydrogen peroxide is selected as the oxidant in an amount of 8-12%.

### Embodiment 3. Selection and Optimization of an Amount of the Acid

In this embodiment, a selection and dosage of the acid is optimized. In consideration of the cost control and the risk control of an etching process, a polycarboxylic acid, an amino acid or an inorganic acid is selected as a component of the Cu—MoTi alloy etching solution according to the disclosure. In comprehensive consideration of safety and cost, it is determined that the acid contained in the Cu—MoTi alloy etching solution of the disclosure is selected form the group consisting of malic acid, citric acid, phosphoric acid, sulfuric acid, glycine or a combination thereof.

It has been experimentally proved that the citric acid can provide a good acidic environment for the etching process, and simultaneously has advantages of high safety and low cost.

A concentration of citric acid is determined to be in the range of 3 to 15%, preferably 5 to 10%, in consideration of the etching effect and the manufacturing cost.

### Embodiment 4. Selection and Optimization of an Amount of the Inorganic Salt

In this embodiment, a selection and dosage of the inorganic salt is optimized. The inorganic salt acts as a buffer in the Cu—MoTi alloy etching solution according to the disclosure. In comprehensive consideration of safety and cost, it is determined that the inorganic salt contained in the Cu—MoTi alloy etching solution of the disclosure is selected from ammonium phosphate salts. The ammonium phosphate salts are selected from the group consisting of ammonium dihydrogen phosphate, diammonium hydrogen phosphate, and ammonium phosphate. In consideration of the etching effect and the manufacturing cost, it is determined that the inorganic salt is ammonium dihydrogen phosphate or diammonium hydrogen phosphate in a concentration of 3 to 15%, preferably 5 to 10%.

### Embodiment 5. Optimized Cu—MoTi Etching Solution A

In this embodiment, an optimized Cu—MoTi alloy etching solution A is provided. The optimized Cu—MoTi alloy etching solution A comprises 8 to 12 wt % hydrogen peroxide, 5 to 10 wt % citric acid, 5 to 10 wt % diammonium hydrogen phosphate, and the balance deionized water. The above components are mixed uniformly to obtain the Cu—MoTi etching solution A.

### Embodiment 6. Optimized Cu—MoTi Etching Solution B

In this embodiment, an optimized Cu—MoTi alloy etching solution B is provided. The optimized Cu—MoTi alloy etching solution B comprises 8 to 12 wt % hydrogen peroxide, 5 to 10 wt % citric acid, 5 to 10 wt % diammonium hydrogen phosphate, 0.01 to 5 wt % phenylurea, and the balance deionized water. The phenylurea acts as a stabilizing agent. The Cu—MoTi etching solution B can be used for an etching process of a plurality of glass substrates.

### Embodiment 7. Optimized Cu—MoTi Etching Solution C

In this embodiment, an optimized Cu—MoTi alloy etching solution C is provided. The optimized Cu—MoTi alloy etching solution B comprises 8 to 12 wt % hydrogen peroxide, 5 to 10 wt % citric acid, 5 to 10 wt % diammonium hydrogen phosphate, 0.01 to 5 wt % of a metal chelating agent, and the balance deionized water. The metal chelating agent is selected from the group consisting of an acminocarboxylate chelating agent, a hydroxycarboxylic acid chelating agent, a tartaric acid, a polyphosphate chelating agent, and a polycarboxylic acid chelating agent. The Cu—MoTi etching solution C can be used for an etching process of a plurality of glass substrates.

### Embodiment 8

In this embodiment, an optimized Cu—MoTi alloy etching solution D is provided and a preparation method is as follows. A 4.8 g citric acid, a 13.2 g diammonium hydrogen phosphate, a 0.3 g phenyl urea and 200 ml mass fraction of 10% hydrogen peroxide are weighed. The above components are mixed uniformly to obtain the Cu—MoTi etching solution.

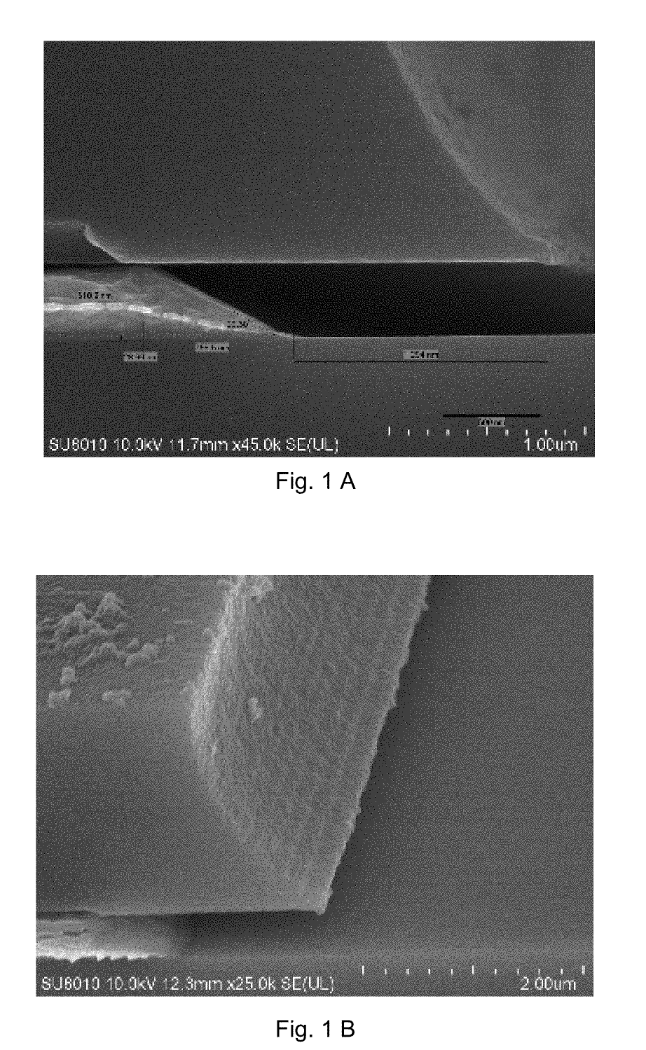

The Cu—MoTi etching solution D is applied to an etching process of Cu—MoTi alloys to obtain microscopic images as shown in FIGS. 1A and 1B. Referring to FIG. 1A, an etched Cu—MoTi wire has a perfect slope angle of about 30°. Referring to FIG. 1B, a top surface of the etched Cu—MoTi wire has no molybdenum residue.

This disclosure has been described with preferred embodiments thereof, and it is understood that many changes and modifications to the described embodiment can be carried out without departing from the scope and the spirit of the invention.

1. A Cu—MoTi alloy etching solution, comprising:
5 to 30 wt % of an oxidant, 3 to 15 wt % of an acid, 3 to 15 wt % of an inorganic salt, and the balance deionized water;
wherein the oxidant is selected from peroxy group-containing compounds, the acid is a polycarboxylic acid, and the inorganic salt is selected from ammonium phosphate salts;
wherein the peroxy group-containing compounds are selected from hydrogen peroxide or its derivatives, the ammonium phosphate salts are selected from the group consisting of ammonium dihydrogen phosphate, diammonium hydrogen phosphate, and ammonium phosphate, and the polycarboxylic acids are selected from the group consisting of a malic acid and a citric acid.

2. The etching solution according to claim 1, wherein the Cu—MoTi etching solution further comprises 0.01 to 5 wt % of a metal chelating agent, the metal chelating agent is selected from the group consisting of an acminocarboxylate chelating agent, a hydroxycarboxylic acid chelating agent, a tartaric acid, a polyphosphate chelating agent, and a polycarboxylic acid chelating agent.

3. The etching solution according to claim 2, wherein the metal chelating agent is selected from the group consisting of ethylenediaminetetraacetic acid, hydroxyethyl ethylenediamine triacetic acid, polyacrylic acid, and polymethacrylic acid.

4. The etching solution according to claim 1, wherein the Cu—MoTi etching solution further comprises 0.01 to 5 wt % of a stabilizing agent.

5. The etching solution according to claim 4, wherein the stabilizing agent is phenyl urea.

6. A Cu—MoTi alloy etching solution, comprising:
5 to 30 wt % of an oxidant, 3 to 15 wt % of an acid, 3 to 15 wt % of an inorganic salt, and the balance deionized water;
wherein the oxidant is selected from peroxy group-containing compounds, and the inorganic salt is selected from ammonium phosphate salts

7. The etching solution according to claim 6, wherein the peroxy group-containing compounds are selected from hydrogen peroxide or its derivatives.

8. The etching solution according to claim 6, wherein the ammonium phosphate salts are selected from the group consisting of ammonium dihydrogen phosphate, diammonium hydrogen phosphate, and ammonium phosphate.

9. The etching solution according to claim 6, wherein the acid is selected from the group consisting of a polycarboxylic acid, an amino acid, and an inorganic acid.

10. The etching solution according to claim 9, wherein the acid is a polycarboxylic acid.

11. The etching solution according to claim 10, wherein the polycarboxylic acids is selected from a malic acid or a citric acid, the amino acid is selected from glycine or alanine, and the inorganic acid is selected from phosphoric acid or sulfuric acid.

12. The etching solution according to claim 6, wherein the Cu—MoTi etching solution further comprises 0.01 to 5 wt % of a metal chelating agent, the metal chelating agent is selected from the group consisting of an acminocarboxylate chelating agent, a hydroxycarboxylic acid chelating agent, a tartaric acid, a polyphosphate chelating agent, and a polycarboxylic acid chelating agent.

13. The etching solution according to claim 12, wherein the metal chelating agent is selected from the group consisting of ethylenediaminetetraacetic acid, hydroxyethyl ethylenediamine triacetic acid, polyacrylic acid, and polymethacrylic acid.

14. The etching solution according to claim 6, wherein the Cu—MoTi etching solution further comprises 0.01 to 5 wt % of a stabilizing agent.

15. The etching solution according to claim 14, wherein the stabilizing agent is phenyl urea.
